(19) United States
(12) Patent Application Publication
(10) Pub. No.: US 2014/0268884 A1
(43) Pub. Date: Sep. 18, 2014

(54) CUSTOMIZED SIGNATURE NIGHT LAMP

(71) Applicant: Chin-sheng YANG, Taina City (TW)

(72) Inventor: Chin-sheng YANG, Taina City (TW)

(21) Appl. No.: 13/802,763

(22) Filed: Mar. 14, 2013

(51) Int. Cl. F21S 8/00

(52) U.S. Cl. CPC F21S 8/035
USPC 362/644

(57) ABSTRACT

A customized signature night lamp is disclosed, including: a main stand, a projection film and a shade. The projection film is disposed at upper part of the main stand and surrounds a light-emitting element disposed at the upper part of the main stand. The projection film includes customized signature pattern able for light to pass through. The shade is engaged to the upper part of the main stand and covers the projection film. The main stand is disposed with an electrical terminal for connecting power supply, and the electrical terminal is connected to the light-emitting element. When the light-emitting element projects light onto the projection film, the customized signature pattern is projected onto the shade to form a personal customized signature lamp.

### FIELD OF THE INVENTION

The present invention generally relates to a customized signature night lamp, and more specifically to a lamp able to accept customized signature, applicable to display in an ambient space.

### BACKGROUND OF THE INVENTION

As the technology, culture and social progress in many aspects, people are pursuing higher quality in daily lives, in particular, the living environment at home.

In daily life, the home decoration utilizes decorative objects to improve visual esthetics, such as, household furnishing and other objects with decorative patterns. However, the majority of decorative pattern designs may not meet the need of the customers, and more and more customers look for personalized and unique decorations for self-expression as well as creating a unique personal space at home.

Therefore, it is desirable to devise a lamp able to display customized signature in addition to decorative capability so as to enhance the esthetics of the household.

### SUMMARY OF THE INVENTION

The primary object of the present invention is to provide a night lamp able to display customized signature, to increase variety of available selections.

To achieve the above object, the present invention provides a customized signature night lamp, including: a main stand, having a circuit, the main stand being disposed with an electrical terminal for connecting the power supply on one side, and being also disposed with a light-emitting element at the top, the light-emitting element being electrically connected to the electrical terminal; a projection film, disposed at the top of the main stand and surrounding the light-emitting element, the projection film having customized signature pattern able for light to pass through; and a shade, able for light to pass through and having an downward opening, the shade being engaged to the top of the main stand and covering the projection film.

As such, when the light-emitting element projects light onto the projection film, the customized signature pattern can be projected onto the shade so that the lamp of the present invention can display personalized decoration.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view according to the invention;

FIG. 2 shows a dissected view according to the invention;

FIG. 3 shows a cross-sectional view according to the invention; and

FIG. 4 shows a schematic view of projection according to the invention.

### DETAILED DESCRIPTION OF THE PREFERRED EMBODIMENTS

The foregoing and other objects, features, aspects and advantages of the present invention will become better understood from a careful reading of a detailed description provided herein below with appropriate reference to the accompanying drawings.

Refer to FIGS. 1-3, which are schematic view, dissected view and cross-sectional view of the present invention, respectively. The customized signature night lamp 1 of the present invention includes a main stand 2, a projection film 3 and a shade 4. The projection film 3 is disposed at the upper part of the main stand 2. The shade 4 is engaged to the upper part of the main stand 2 and covers the projection film 3.

The main stand 2 is a stand with a circuit. One side of the main stand 2 is disposed with an electrical terminal 21 for connecting a power supply, and the upper part of the main stand is disposed with a light-emitting element 22 electrically connected to the electrical terminal 21. The light-emitting element 22 can be a light-emitting diode (LED), which can provide a variety of light colors to further enhance the visual effect of the present invention. The main stand 2 includes a switch 23, which is a conventional design for electronic device, and will not be described in details here.

The projection film 3 is disposed at the upper part of the main stand 2 and surrounds the light-emitting element 22. The surface of the projection film 3 includes a customized signature pattern 31. In the present embodiment, the projection film 3 is a film made of plastic. Other than the customized signature pattern 31, the remaining part of the projection film 3 is opaque and not light-transmittable.

The shade 4 allows the light to pass through and has a downward opening 41. The shade 4 is engaged to the upper part of the main stand 2 and covers the projection film 3. In the present embodiment, the shade 4 shows a snowman appearance. The shape and appearance in the present invention is only for illustrative instead of restrictive, purpose.

Furthermore, the night lamp 1 of the present invention further includes a fixed base 5, in a shape of an upside-down dish, without neither the top nor the bottom. The fixed base 5 is disposed between the main stand 2 and the shade 4. The outer edge of the fixed based 5 fits the projection film 3. Both the bottoms of the shade 4 and the projection film 3 rest on a shoulder 51 extending outwards from the fixed base 5. The inner edge of the fixed base 5 sheathes over the outer circumference of the upper part of the main stand 2. The inner edge of the fixed base 5 includes a plurality of protruding ribs 52. Each rib 52 presses against the outer edge of the upper part of the main stand 2. The fixed base 5 is mainly for fixing the shade 4 and the projection film 3 to the upper part of the main stand 2 so that when moving the night lamp 1, the shade 4 and the projection film 3 are firmly held.

As such, the customized signature pattern 31 can be a personal name or a signature, which can be formed by using laser engraving to form auxiliary patterns with reserved space for the signature. The signature can be written by the customer and engraved by computer engraving to form personal signature. The fixed base 5 can also be an extension part of the projection film 3 to reduce the assembly.

Referring to FIG. 4, the light-emitting element 22 projects light on the projection film 3 so as to project the customized signature pattern 31 on the shade 4. As such, a night lamp with customized signature is formed.

In summary, the present invention shows features of progression and industrial utilization and the structure and the features of the present invention has never been publicly disclosed, thus, shows feature of novelty. Therefore, the present invention meets the requirements of patent application.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A customized signature night lamp, comprising:
a main stand, having a circuit, the main stand being disposed with an electrical terminal for connecting the power supply on one side, and being also disposed with a light-emitting element at the top, the light-emitting element being electrically connected to the electrical terminal;
a projection film, disposed at the top of the main stand and surrounding the light-emitting element, the projection film having customized signature pattern able for light to pass through; and
a shade, able for light to pass through and having an downward opening, the shade being engaged to the top of the main stand and covering the projection film.

2. The customized signature night lamp as claimed in claim 1, wherein the customized signature pattern is formed by laser engraving.

3. The customized signature night lamp as claimed in claim 1, wherein the night lamp further comprises a fixed base, disposed between the main stand and the shade, and the fixed base extends partially into the projection film.

4. The customized signature night lamp as claimed in claim 3, wherein the fixed base is an extension part of the projection film.
